(19) United States
(12) Patent Application Publication
(10) Pub. No.: US 2017/0072655 A1
(43) Pub. Date: Mar. 16, 2017

(54) SEALING UNIT, SEALING APPARATUS, METHOD FOR MANUFACTURING AIR OR GAS FILLED BAGS, AND AIR OR GAS FILLED BAG

(71) Applicant: Ideepak Holding B.V., Stramproy (NL)

(72) Inventor: Pieter Theodorus Joseph AQUARIUS, Stramproy (NL)

(21) Appl. No.: 15/123,461

(22) PCT Filed: Mar. 4, 2015
(86) PCT No.: PCT/NL2015/050133

§ 371 Date: Sep. 2, 2016

(30) Foreign Application Priority Data
Mar. 4, 2014 (NL) 2012357

(51) Int. Cl. B31D 5/00; B65B 51/10; B65B 41/12; B65B 7/02

(52) U.S. Cl. CPC B31D 5/0073; B65B 7/02; B65B 51/10; B65B 41/12; B31D 2205/0023; B31D 2205/0047

(57) ABSTRACT

A sealing unit for heat-sealing two layers of film material. Two endless conveying belts each have an outwardly facing first surface. In use, the first surfaces extend partly side by side to form two conveying surfaces facing each other, enabling film material to be clamped therebetween. Driving means drive the two endless conveying belts in opposite direction of circulation, thereby enabling film material clamped between the facing conveying surface parts to be carried in a film feed direction. At least one heating means for heating the film material is provided adjacent to an inwardly facing second surface of a first one of the endless conveying belts, preferably at a position where the conveying belts are partly extending side by side each other during use. Driving members for driving the first conveying belt are located at least partly at opposite lateral sides of the at least one heating means.

The invention relates to a sealing unit for heat-sealing two layers of film material.

Such sealing units are known and are generally used in a sealing apparatus for filling bags formed in preconfigured film material with air or another suitable gas, including gas mixtures, and then sealing them tight. The thus obtained air or gas filled bags can be used as filling material in packages, to protect products received in said packages. To that end, a known sealing apparatus comprises an air or gas supply unit, a sealing unit, which sealing unit comprises a heating means, and conveying means for carrying the film material along these processing units. Normally, the conveying means comprise two circulating belts or strips, e.g. made of Teflon tape. Each of the belts can be guided along a guiding block and said belts are driven in opposite direction of circulation, for instance by means of suitable driven rollers, so that the preconfigured film material can be carried along there between. Generally, at least one of the guiding blocks is provided with heating means, usually in the form of a sealing wire extending under the respective circulating belt. With this, the guiding block can also function as a sealing block, in cooperation with the other guiding block, which then may function as a counter block and/or which may itself be provided with a second heating element, so that the preconfigured film material carried therealong can be heated two-sidedly.

A disadvantage of known such sealing units is that the preconfigured film material can be pulled out of position relatively easily, especially at or near a location where it is conveyed along the heating means. For example, the two layers of film material positioned on top of each other may be partly moved with respect to each other unintentionally. As a result, one or both of the layers may crease, wrinkle or fold, due to which the thickness of these superimposed layers can increase. As the sealing unit is not designed or adjusted for such an increased film thickness, this may result in a relatively weak heat-seal seam between said two layers of preconfigured film material, or may even result in that the apparatus fails in heat-sealing the layers properly together, thereby resulting in a leak or flat bag. Furthermore, a creased air or gas filled bag may not look attractive. Alternatively or additionally, pulling the preconfigured film material out of position can cause that a newly formed heat-seal, which then is still warm and therefore relatively plastically deformable, deforms unintentionally. As a result, the heat-sealed seam may become damaged and/or the bag can look sloppy. Besides, the film material being pulled out of position may accidentally end up between parts, especially moving parts, of the sealing apparatus, such as for instance moving parts of its sealing unit, especially conveying parts of the sealing unit. This for instance may damage the film material and/or may cause said parts or apparatus to jam.

An object of the invention is to provide an alternative sealing unit for heat-sealing two layers of film material, especially for in a sealing apparatus for filling bags formed in preconfigured film material with air or another suitable gas, e.g. a gas mixture, and then sealing them tight. In particular, it is an object of the present invention to alleviate or solve at least one disadvantage of known sealing units or sealing apparatus, especially at least one disadvantage mentioned above. More in particular, the invention aims at providing a sealing unit, wherein can be counteracted that bags, formed by means of said sealing unit, can have a relatively weak heat-sealed seam and/or look relatively unattractive. In embodiments, the present disclosure aims at providing a sealing unit or sealing apparatus which can counteract that film material will be pulled out of position.

These and/or further objects are at least partly achieved with a sealing unit according to the invention, characterized by the features of claim 1.

In a first aspect of the disclosure, the present disclosure provides for a sealing unit for heat-sealing two layers of film material, comprising two endless conveying belts each having an outwardly facing first surface, during use said first surfaces partly extending side by side each other such as to form two conveying surfaces facing each other, thereby enabling to clamp film material between said facing conveying surface parts, the unit comprising driving means for driving the two endless conveying belts in opposite direction of circulation, thereby enabling to carry film material clamped there between in a film feed through direction, the unit further comprising at least one heating means for heating the film material, the at least one heating means being provided adjacent to an inwardly facing second surface of a first one of the endless conveying belts, preferably at a position where the conveying belts are partly extending side by side each other during use, wherein the driving means comprise two driving members for driving the first conveying belt, said two driving members being located at least partly at opposite lateral sides of the at least one heating means.

By providing two driving members for driving the first conveying belt, and locating said two driving members at least partly at opposite lateral sides of the at least one heating means, the film material can be clamped and carried at both lateral sided of the heating means. As a result, it can be counteracted that portions of film material positioned at opposite lateral sides of the heating means are unintentionally moved with respect to each other. Actually, it may be counteracted that at the one hand a portion of film material positioned at a first lateral side of the heating means is clamped between two facing conveying surface parts of two conveying belts and is pulled in the film feed through direction by said parts of the belts, but that on the other hand a second portion of film material positioned at the opposite lateral side of the heating means is not tightly clamped and pulled directly by means of said conveying belts, but that said second portion is only pulled along by the first portion of film material positioned at the first lateral side and connected to the second portion by means of an intermediate portion, which intermediate portion then can be relatively weak due to heat-sealing of said intermediate portion. As a result, tensile stresses in a newly formed heat-seal, which is still warm and therefore relatively plastically deformable, can for instance be limited relatively well. For example therefore, it may be counteracted that forming a heat-sealed seam fails, that the heat-sealed seam gets damaged and/or becomes relative weak, at least partly, and/or that the heat-sealed seam and/or the bag looks relatively unattractive.

For example, the two driving members can be formed by two endless drive belts extending at least partly at two opposite lateral sides of the at least one heating means. By forming the driving members by said drive belts, instead of for instance forming them by two parallel drive wheels, the conveying belts can be supported by the driving members over a relatively long distance, seen in the film feed through direction or so-called conveying direction.

By designing the two drive belts as a toothed drive belts, it can be counteracted that these drive belts may slip easily during use.

By providing the driving means with a driving element arranged for driving both driving members, e.g. both toothed drive belts, both driving members may be driven by a single driving element, e.g. a toothed drive-wheel. Hence, it can be facilitated in a relatively elegant manner that both driving members, e.g. both toothed drive belts, are moved at the same speed, such that may be counteracted too an even greater extent that the film material is pulled out of position while it is fed through the sealing unit.

The invention also relates to a sealing apparatus, preferably a sealing apparatus comprising a sealing unit as disclosed above. Said sealing apparatus may comprise an air or gas supply unit for the supply of air or gas between two layers of film material to be interconnected, wherein said supply unit can comprise an air or gas outflow opening which, in film feed through direction, can preferably be located at least partly upstream of facing conveying surface parts of two endless conveying belts for e.g. feeing the film material along the air or gas supply unit and a heating means. Additionally or alternatively, the apparatus may comprise a guiding element, preferably an elongated guiding element, more preferably a substantially rod-shaped guiding element, extending substantially counter to the film feed-through direction, preferably at least partly upstream of the outflow opening. In embodiments, said apparatus can also comprise a knife, preferably a knife provided at the guiding element, more preferably upstream of the air or gas outflow opening.

The present disclosure also relates to a sealing apparatus provided with a knife positioned at a lateral side of a guiding element, preferably wherein during use said knife is substantially extending in a plane substantially parallel with film material being conveyed through and/or along a sealing unit, more preferably wherein said knife is positioned off centre with respect to said guiding element, seen in the direction of the thickness of film material being conveyed in use, wherein said thickness direction extends substantially transverse to the feed-through direction and substantially transverse to the width of the film material being conveyed in use. By positioning the knife off centre with respect to guiding element, preferably by positioning it higher or lower than a central axis of a substantially rod-shaped guiding element, it can be enabled in a relatively elegant manner that two layers of a strip of preconfigured film material are cut loose near a heat-sealed seam of a pre-sealed side edge of said strip, substantially without cutting through said heat-sealed seam. As a result, it be counteracted that slivers loosens at least partly from the strip of preconfigured film material, thereby counteracting that such slivers can end up between moving parts of the sealing apparatus and can pull the strip of film material out of position and/or can jam the sealing apparatus.

It is noted that the invention also relates to a method for manufacturing air or gas filled bags from preconfigured film material and to air or gas filled bags manufactured by such method.

Advantageous embodiments of the invention are described below and in the appended claims.

By way of non-limiting examples only, embodiments of the present invention will now be described with reference to the accompanying drawing in which:

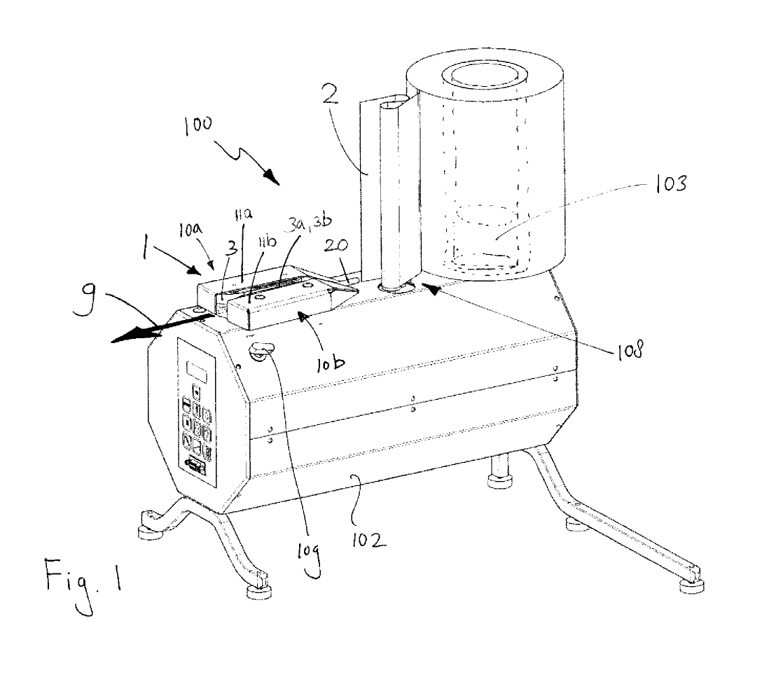

FIG. 1 shows a schematic perspective view of an embodiment of a sealing apparatus provided with a sealing unit according to an aspect of the invention;

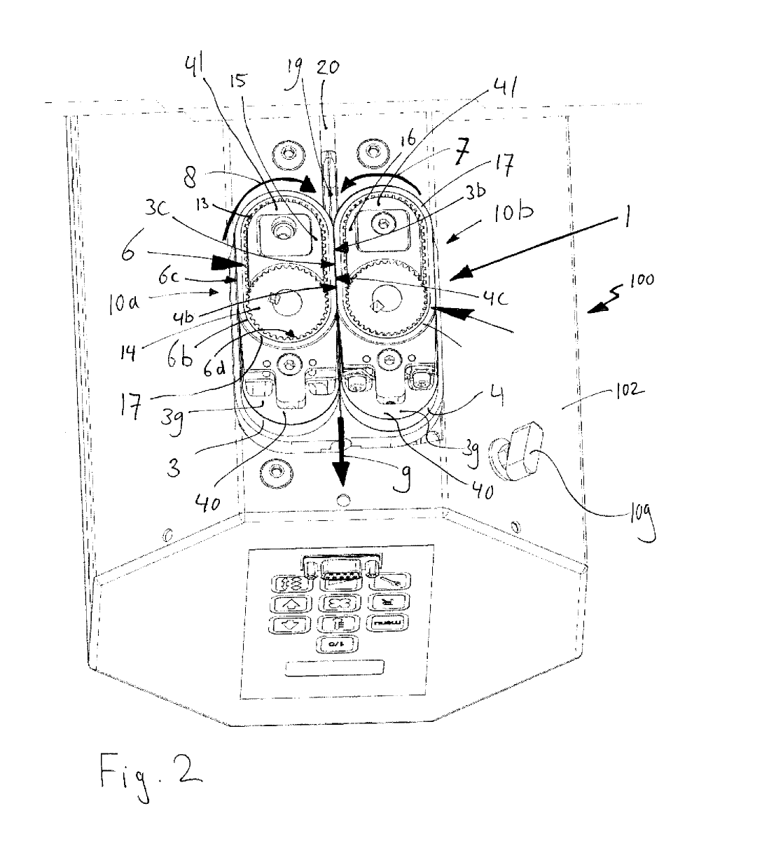

FIG. 2 shows a schematic perspective view showing a detail of the inventive sealing unit of FIG. 1;

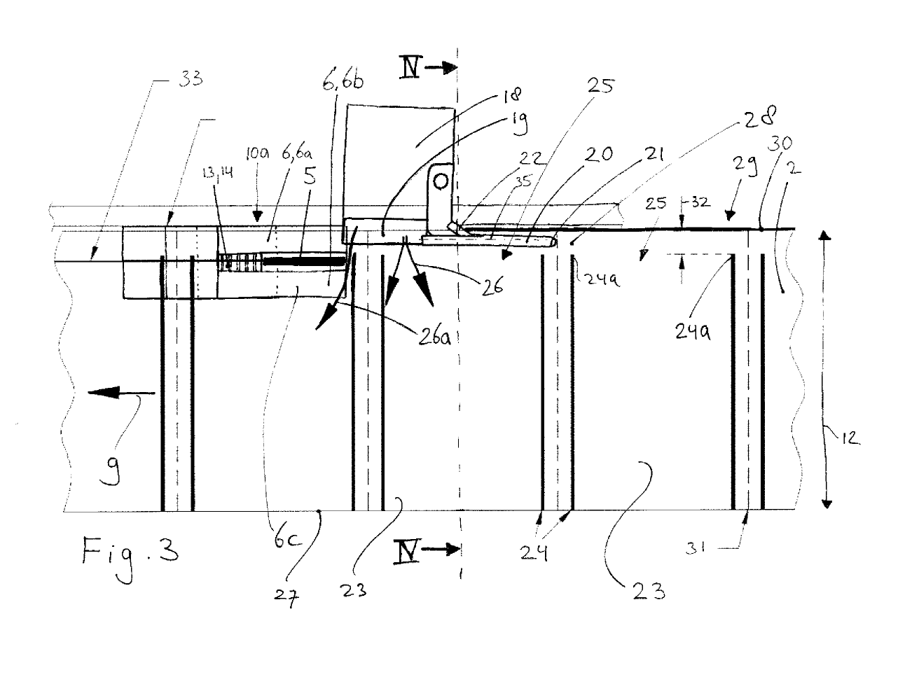

FIG. 3 shows a schematic cross-sectional view of an embodiment of a sealing unit according to the invention and a strip of preconfigured film material processed by said sealing unit; and

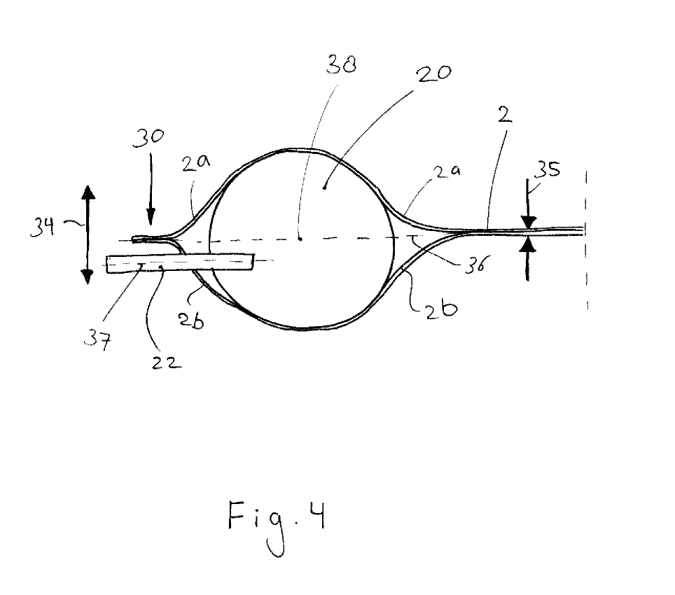

FIG. 4 shows a further schematic cross-sectional view of the sealing unit of FIG. 3 and a strip of preconfigured film material processed by said sealing unit.

The embodiments disclosed herein are shown as examples only and should by no means be understood as limiting the scope of the claimed invention in any way. In this description, the same or similar elements have the same or similar reference signs. The sealing unit and the sealing apparatus or so-called sealing device and the operation thereof will merely be explained in as far as required for a proper understanding of the present invention. For more detailed explanations, for instance a more detailed explanation of the preconfigured film material, reference is made to the international patent publications WO 01/85434, WO 2006/003524, and WO 2006/101391, which are understood to be included herein by reference.

FIGS. 1 and 2 show, in schematic perspective views, a sealing apparatus 100 provided with a sealing unit 1 according to an aspect of the invention. The inventive sealing unit 1 is arranged for heat-sealing two layers 2a, 2b of film material 2. For example, the sealing unit 1 may be provided at an outside of a housing 102 or frame of the sealing apparatus 100. It is noted that said housing 102 may be provided with a shaft 103, film roll holder or other film material holder for holding the film material 2, preferably a roll of film material. The apparatus 100 can further be provided with guiding provision 108 for guiding the film material 2 according to a desired path from the roll towards the sealing unit 1. It is noted that the film material 2 may for instance be or comprise a plastic material that can be heat sealable, such as for instance a thermoplastic material. Preferably, the film material can be substantially transparent or translucent. Alternatively or additionally, at least a part of the film material 2 may be opaque and/or may be coloured. Advantageously, the guiding provision 108 can also be arranged for tightening the film material such that formation of creases can be counteracted.

Referring to FIG. 1, it is noted that oppositely provided parts or so-called seal jaws 10a, 10b of the sealing unit 1 are moved apart with respect to each other to some extent. Hence, the film material 2 can be disposed between those seal jaws and can then be clamped between them, before starting the manufacturing of air or gas filled bags. In order to facilitated this, the apparatus 100 may be provided with one or more seal jaw locks 109 for loosening and temporarily fixating at least one of the seal jaws 10. Further, it is noted that the seal jaws 10a, 10b can be provided with one or more seal jaw covers 11a, 11b for covering at least a portion of the seal jaws 10a, 10b, especially at least partly covering moving parts thereof. It is noted that, in embodiments, the sealing unit 1 can be substantially formed by the two so-called seal jaws 10a, 10b, which may comprise at least a part of the parts or so-called elements of the sealing unit described below.

With regard to FIG. 2, it is noted that the seal jaw covers 11a, 11b are omitted in order to show the parts of the sealing unit 1. Hence, it can be seen that the sealing unit 1 comprises two endless conveying belts 3, 4, each of which can be provided in a respective one of the seal jaws. It is noted that each of the conveying belts 3, 4 has an outwardly facing first surface 3a, 4a, wherein, at least during use, said surfaces are partly 3b, 4b extending side by side each other such as to form two conveying surfaces facing each other, thereby enabling to clamp film material 2 between said facing conveying surface parts 3b, 4b, such that said film material 2 can be clamped between the two seal jaws 10a, 10b. Advantageously, the conveying belts 3, 4 may comprise and/or may be made off a heat resistant and/or anti-stick or so-called non-stick material, such as for instance Teflon, Nylon, Silicone et cetera.

The sealing unit 1 also comprises driving means 6 for driving the two endless conveying belts 3, 4 in opposite direction of circulation 7, 8, thereby enabling to carry film material 2 clamped there between in a film feed through direction 9 or so-called conveying direction 9. As can be seen in FIG. 2, the driving means 6 may comprise at least two driving means 6, each of which can correspond to a respective conveying belt 3, 4. Advantageously, each of the driving means 6 can be positioned at least partly within a space enclosed by the corresponding conveying belt 3, 4.

FIG. 3 shows a schematic cross-sectional view of an embodiment of a sealing unit 1 according to the invention and a strip of preconfigured film material 2 processed by said sealing unit 1. In said schematic view, one jaw 10b of said two seal jaws has been omitted, such that a portion of the film material 2 which during use is positioned between conveying surface parts 3b, 4b of the two endless conveying belts 3, 4 is visible. Here, the film material 2 is formed by a substantially transparent material, such that the other seal jaw 10a provided at the opposite side of said portion of the film material is visible through said film material. In order to unhide the respective parts of said seal jaw 10a, its conveying belt 3 has been omitted in FIG. 3. Therefore, it can be seen that the sealing unit 1 comprises at least one heating means 5 for heating the film material 2, especially through said conveying belt 3 here omitted for clarity reasons. It is noted that the heating means for instance may comprise an electric heating element, e.g. comprising a resistor element. Preferably, the heating means 5 can be arranged for forming a heat-sealed seam or weld seam in film material 2 which extends substantially in the film feed through direction 9. For instance, the heating means 5 can comprise an elongated heating element, e.g. a heating wire 5 or so-called heating thread, which can extend substantially in the conveying direction 9.

Said at least one heating means 5 is provided adjacent to an inwardly facing second surface 3c of a first one 3 of the endless conveying belts. Advantageously, the heating means 5 may be positioned at least partly, preferably completely, within a space enclosed by said first conveying belt 3. Preferably, the heating means 5 can be disposed at a position where the conveying belts 3, 4 are partly extending parallel and/or side by side each other during use.

It is noted that the driving means 6 comprise two driving members 6a, 6b for driving the first conveying belt 3. As best can be seen in FIG. 3, said two driving members 6a, 6b are located at least partly at opposite lateral sides of the at least one heating means 5. This is, in a width direction 12 of the conveyed film material, said heating means 5 is located between said two driving members 6a, 6b. An advantage of such arrangement may lie in that heat provided by the heating means 5 does not have to go through the driving members 6a, 6b, e.g. through two endless drive belts 6a, 6b, in order to reach the film material of which two layers are to be heat-sealed together. As a result, for instance relatively little heat can be used, which can be efficient and/or which may counteract overheating of parts of the sealing unit 1. This may be even more advantageous in case the driving members 6a, 6b have a relative large thickness and/or when they are made of a material providing for relatively limited heat conduction and/or relatively great insulation, such as is often the case with resilient materials.

Advantageously, the two driving members 6a, 6b can be arranged for supporting the inwardly facing second surface 3c of the first conveying belt 3 at least partly, such as to counteract to a certain extent that the conveying surface part 3b of said first conveying belt can be pushed away in a direction away from the conveying surface part 4b of the second conveying belt 4. Hence, the driving members may facilitate that the film material 2 can be clamped between the facing conveying surface parts 3b, 4b of the conveying belts 3, 4.

In embodiments, the two driving members 6a, 6b can be formed by two endless drive belts 6a, 6b extending at least partly at two opposite lateral sides of the at least one heating means 5. However, in alternative embodiments, the two driving members 6a, 6b may be formed differently, e.g. by designing them as two driving rollers.

It is noted that each of the two drive belts 6a, 6b can be a toothed drive belt having an outwardly facing first surface 6c for supporting at least a part of the inwardly facing second surface 3c of the first conveying belt 3, and having an inwardly facing second surface 6d provided with teeth 13 for cooperation with a toothed drive-wheel 14.

Although each of the two endless conveying belts 3, 4 can run at least partly around its respective driving means 6, e.g. its two driving members 6a, 6b or two endless drive belts 6a, 6b, and can be guided thereby at least partly, it is noted that the respective belt 3, 4 may additionally also be guided at least partly by other means, such as for instance by one or more guiding rollers and/or one or more substantially stationary guides, such an at least partly rounded guide part 39, which preferably may comprises a wear-resistant material, e.g. aluminium.

It is noted that the endless conveying belts 3, 4 can be biased or tensioned by means of one or more conveying belt tensioners 40 and/or that the two endless drive belts 6a, 6b can be biased or tensioned by means of one or more drive belt tensioners 41. Preferably, the respective belt 3, 4, 6a, 6b may be biased or tensioned substantially in the film feed through direction 9 and/or in the opposite direction.

Advantageously, the driving means 6 can comprise a driving element 14 which is arranged for driving both driving members 6a, 6b. As can be seen in FIG. 3, where a contour of the toothed drive-wheel 14 of the first seal jaw 10a is shown by dotted lines, the driving element 14 may be formed by a toothed drive-wheel 14 for driving the two toothed drive belts 6a, 6b.

In embodiments, at least a part of the conveying surface part 3b of the first conveying belt 3 can be supported by a first supporting block 15, and/or at least a part of the conveying surface part 4b of the second conveying belt 4 can be supported by a second supporting block 16. Hence, the respective seal jaw(s) may for instance provide for counter pressure when the film material 2 is clamped between the two seal jaws 10a, 10b. For instance, the first supporting block 15 can support said at least part 3b of the first conveying belt 3 indirectly by supporting respective parts of the two endless drive belts 6a, 6b that are extending between said at least part 3b of the first conveying belt 3 and said supporting block 15.

Advantageously, at least one of the endless drive belts 6a, 6b and/or at least one of the supporting blocks 15, 16 can be provided with a layer 17 of resilient material. The resilient layer 17 can distribute a sealing force applied by the two seal jaws 10a, 10b relatively evenly over the film material. As during use the endless drive belts 6a, 6b are in motion, said belts can discharge at least a part of the heat produced during sealing from the sealing area and thus counteract accumulations of heat between the seal jaws. For example, the resilient layer 17 can be placed on top of a carrier, which may for instance comprise the teeth 13. The resilient layer 17 can have a relatively great thickness with respect to a carrier layer, in order to offer a sufficiently great path of compression.

As can be seen in FIGS. 2 and 3, the sealing apparatus 100 can comprise an air or gas supply unit 18 for the supply of air or gas between two layers 2a, 2b of film material 2 to be connected. Said air or gas supply unit 18 can comprise an air or gas outflow opening 19 which, in film feed through direction 9, can be located at least partly upstream of the facing conveying surface parts 3a, 4b of the two endless conveying belts 3, 4.

Additionally or alternatively, the sealing apparatus 100 can comprise a guiding element 20, preferably an elongated guiding element 20. The guiding element 20 can be a substantially rod-shaped guiding element 20, preferably having a tapered, chamfered and/or rounded off distal end portion 21. The guiding element 20 can extend substantially counter to the film feed-through direction 9. In embodiments, the guiding element 20 can be located at least partly upstream of the air or gas outflow opening 19.

Further, the sealing apparatus 100 can comprise a knife 22. The knife 22 can be provided at the guiding element 20, especially at a proximal end part of said guiding element. Additionally or alternatively, the knife 22 can be located upstream of the air or gas outflow opening 19.

In embodiments, the preconfigured film material can comprise at least two layers 2a, 2b between which compartments 23 or so-called pockets 23 can be defined that are arranged for forming bags filled with air or any suitable gas, which may be a gas mixture. Said pockets 23 can be divided from each others by means of one or more so-called heat-seals 24, seams 24 or welds 24, which may be separated by means of perforations 31 that can form a tear line for easy detaching pockets 23 from each other. Said heat-seals 24 may extend from an open side 25 of the pocket 23 up to a lateral boundary 27 limiting a lateral side of the pocket 23. For example, such as in the embodiment of FIG. 3, said lateral boundary 27 can be formed by and/or comprise a fold 27 along which the layers 2a, 2b are folded with respect to each other. However, in embodiments, said lateral boundary 27 can for instance be formed by and/or comprise a heat-seal, seam or weld. Furthermore, the pockets 23 can have an open side 25 through which gas 26, preferably air, can be inserted into said pocket or so-called compartment 23. Preferably, the apparatus 100 can be arranged such that during use the sealing unit 1 seals off the open side 25 of a respective pocket after and/or while air or gas 26 is disposed into said respective pocket 23.

During use of the sealing apparatus 100, the preconfigured film material 2 can be fed towards the sealing unit 1. For example, the elongated guiding element 20 can extend at least partly through a tunnel shaped space 28 between the two layers 2a, 2b of said film material 2. Said tunnel shaped space 28 may be closed of at a lateral side 29 of the film material 2 by means of an elongated heat-seal 30 or fold, preferably extending substantially in the feed through direction 9. Further, said tunnel shaped space 28 may be at least partly open at an opposite lateral side of said space 28, e.g. in order to provide for open sides 25 of the pockets 23. It is noted that said opposite lateral side of said tunnel shaped space 28 can be defined at least partly by means of proximal end portions 24a of the heat-seals 24 dividing the pockets from each other. Preferably, the width 32 of the tunnel shaped space 28 is chosen such that at one hand it is wide enough to facilitate that the film material 2 can be moved relatively easily along the elongated guiding element 20 and such that at the other hand it is small enough to counteract that too much air or gas 26 is escaping form the pocket 23 to be filled into said tunnel shaped space 28 and/or into an adjacent pocket located stream downward.

As can be seen in FIG. 3, the air or gas outflow opening 19 may be located stream downward of the heating means 5 of the sealing unit 1, preferably very closely in front of the heating means 5, such that additional air 26a may enter a compartment of which the open side 25 is almost completely sealed off already by means of a heat-seal 33, in order to inflate said compartment a little extra just before it is closed off. It is noted that said heat-seal 33 is formed by said heating means 5 and can extend in the longitudinal direction of the film material 2, preferably it may be extending substantially in the film feed through direction 9. Hence, it can be counteracted that the finished air or gas filled bags are not blown up hard enough.

Further it can be seen in FIG. 3 that the knife 22 may be positioned at a lateral side of the guiding element 20, preferably a lateral side opposite a lateral side at which the air or gas outflow opening 19 is located. Preferably, the knife 22 or one or more cutting edges thereof can extend diagonally backwards, e.g. extend away from the guiding element 20 in a direction having both a lateral component and a backward component which is directed in the film feed through direction 9. Said knife 22 can be arranged for cutting open the tunnel shaped space 28 at or near the elongated seam 30, e.g. the heat-seal 30 or fold, located at the lateral side 29 of the film material 2. Preferably, said knife 22 can be substantially extending in a plane substantially parallel with the film material 2 being conveyed in use.

Advantageously, such as shown in FIG. 4, which shows a further schematic cross-sectional view of the sealing unit 1 of FIG. 3 and a strip of preconfigured film material 2 processed by said sealing unit 1, the knife 22 can be positioned off centre with respect to the guiding element 20, seen in the direction 34 of the thickness 35 of film material 2 being conveyed in use. It is noted that said thickness direction 34 extends substantially transverse to the feed-through direction 9 and substantially transverse to the width 12 of the film material 2 being conveyed in use. Additionally or alternatively, the knife 22 can be positioned off centre with respect to a centre plane 36 of the film material 2, especially wherein said centre plane 36 can substantially extend between the two layers 2a, 2b of the film material 2. Additionally or alternatively, the knife 22 may be positioned off centre with respect to the sealing unit 1, especially off centre with respect to the facing conveying surface parts 3b, 4b of two respective seal jaws 10a, 10b. For example, said knife can be offset with respect to a plane extending between said two conveying surface parts 3b, 4b.

By positioning the knife 22 off centre, e.g. with respect to the guiding element 20, preferably by positioning it higher or lower than a central axis 38 of a substantially rod-shaped guiding element 20 and/or higher or lower than the centre plane 36 of a respective portion of a strip of film material, it can be enabled in a relatively elegant manner that two layers 2a, 2b of said strip of preconfigured film material 2 are cut loose near a heat-sealed seam 30 located at a lateral side 29 of said film material 2, substantially without cutting through said heat-sealed seam 30. Actually, the knife 22 can be substantially arranged to cut merely through only one of said two layers 2a, 2b. As a result, it may be counteracted that slivers loosens at least partly from the strip of preconfigured film material 2. Therefore, it may also be counteracted that such slivers can end up between moving parts of the sealing apparatus 1, and/or that the strip of film material 2 will be pulled out of position at least partly due to a partly loosened sliver ended up between moving parts, and/or that slivers will jam the sealing apparatus 1.

In embodiments, a centre plane 37 of the knife 22 can be offset with respect to a centre plane 36 of the film material 2 and/or with respect to a centre plane of the guiding element 20 extending substantially parallel with a portion of the material 2 which is fed through the sealing unit 1. Advantageously, the knife 22 can be off centre to such extent that both a top surface and a bottom surface of the knife are positioned at the same side of the centre plane 36 of the film material 2 and/or the centre plane of the guiding element 20 and/or the facing conveying surface parts 3b, 4b of the two endless conveying belts 3, 4. It is noted that the knife 22 may for instance have one cutting edge provided at a distal end portion of the knife, which cutting edge may be located at or near the top surface of the knife, at or near the bottom surface of the knife, or somewhere there between, e.g. centrally in the thickness direction of the knife. Alternatively, the knife 22 may comprise multiple, e.g. two, cutting edges provided at the distal end portion of the knife, i.e. at an upstream portion of the knife 22. Then, for instance one of the cutting edges can be located at or near the top surface, whereas the other one may be located at or near the bottom surface of the knife 22.

Advantageously, the knife 22 or at least a distal end portion thereof comprising the one or more cutting edges can have a thickness being smaller than the thickness or diameter of the guiding element 20. For example, the guiding element 20 can have a thickness being 2 to 25 times, preferably 4 to 10 times, such as for instance about 5, 6 or 7 times, the thickness of the knife or the thickness of the distal end portion thereof. In embodiments, the knife 22 may for instance have a thickness between 0.5 to 2.5 mm, e.g. about 1 mm, whereas the guiding element 20 can have a thickness between 3 to 15 mm, e.g. about 5, 6 or 7 mm.

In embodiments, the knife 22 may be off centre to such extent that its top surface, it lower surface, its centre plane 37, and/or one of its cutting edges is off centre with respect to the centre plane 36 of the film material 2 and/or the central axis 38 of the guiding element 20 over distance between 5% and 50% of the thickness or diameter of said guiding element, preferably between 10% and 35%, such as for instance about 15%, 20%, or 25% thereof.

It is noted that the invention also relates to a method for manufacturing air or gas filled bags from preconfigured film material. In said method air or gas filled bags can be manufactured, for instance by means of a sealing unit and/or a sealing apparatus as disclosed in the present disclosure. Furthermore, the invention also relates to an air or gas filled bag, and/or to a strip of such bags, manufactured by such method.

For the purpose of clarity and a concise description, features are described herein as part of the same or separate embodiments, however, it will be appreciated that the scope of the disclosure may include embodiments having combinations of all or some of the features described. For example, it is noted that although the inventive off centre position of the knife is here mainly described in combination with an inventive sealing apparatus provided with a sealing unit having a driving means that comprises two driving members for driving its first conveying belt, wherein said two driving members are located at least partly at opposite lateral sides of a heating means of said sealing unit 1, it is apparent to a person skilled in the art that such an inventive off centre position of the knife can also be advantageous in other sealing units and/or sealing device and/or methods for manufacturing air or gas filled bags, e.g. without a driving means that comprises two driving members located at least partly at opposite lateral sides of a heating means.

As another example, it is noted that for the purpose of clarity and a concise description, many features have only be explicitly described for the first seal jaw 10a and/or in relation with the first conveying belt 3. However, it is apparent that the second jaw 10b and/or the second conveying belt 4 can also comprise one or more of these features. For instance, the second jaw 10b can comprise a heating means, and/or a driving means 6 having two driving members, e.g. two toothed driving belts, et cetera.

The invention is not restricted in any manner to exemplary embodiments described above and/or depicted in the drawing. All combinations of (parts of) embodiments described and/or shown are understood to fall within the inventive concept. It will be understood that many variants are possible.

For example, the housing of the sealing apparatus may be arranged to be mountable to a stillage, such as a workbench or the like, in multiple positions such that a central axis of the shaft or film roll holder in one of said multiple positions will extend in a different direction with respect to the feed through direction and/or with respect to a longitudinal direction of the housing than in another one of said multiple positions, and/or such that, in one of said multiple positions, the conducting direction will extend in a different direction with respect to the direction of the central axis of the shaft or film roll holder than in another one of said multiple positions.

Further, it is noted that the two driving members, e.g. two driving wheels or two endless drive belts, may be positioned substantially next to each other and/or substantially parallel to each other.

These and other embodiments will be apparent to the person skilled in the art and are considered to lie within the scope of the invention as formulated by the following claims.

1. Sealing unit for heat-sealing two layers of film material, comprising:
two endless conveying belts each having an outwardly facing first surface, during use said first surfaces partly extending side by side each other such as to form two conveying surfaces facing each other, thereby enabling to clamp film material between said facing conveying surface parts;
driving means for driving the two endless conveying belts in opposite direction of circulation, thereby enabling to carry film material clamped between said facing conveying surface parts in a film feed through direction; and
at least one heating means for heating the film material, the at least one heating means being provided adjacent to an inwardly facing second surface of a first one of the endless conveying belts, preferably at a position where the conveying belts are partly extending side by side each other during use,
wherein the driving means comprise two driving members for driving the first conveying belt, said two driving members being located at least partly at opposite lateral sides of the at least one heating means.

2. Sealing unit according to claim 1, wherein the two driving members are arranged for supporting the second surface of the first conveying belt at least partly, such as to limit the extent in which the conveying surface part of said first conveying belt can be pushed away in a direction away from the conveying surface part of the second conveying belt.

3. Sealing unit according to claim 1, wherein the two driving members are formed by two endless drive belts extending at least partly at two opposite lateral sides of the at least one heating means.

4. Sealing unit according to claim 3, wherein each of the two drive belts is a toothed drive belt having an outwardly facing first surface for supporting at least a part of the inwardly facing second surface of the first conveying belt, and having an inwardly facing second surface provided with teeth for cooperation with a toothed drive-wheel.

5. Sealing unit according to claim 4, wherein the driving means comprise a driving element arranged for driving both driving members, the driving element preferably being a toothed drive-wheel for driving the two toothed drive belts.

6. Sealing unit according to claim 1, wherein at least a part of the conveying surface part of the first conveying belt is supported by a first supporting block and/or wherein at least a part of the conveying surface part of the second conveying belt is supported by a second supporting block.

7. Sealing unit according to claim 6, wherein the first supporting block supports said at least part of the first conveying belt indirectly by supporting respective parts of the two endless drive belts that are extending between said at least part of the first conveying belt and said supporting block.

8. Sealing unit according to claim 6, wherein at least one of the endless drive belts and/or at least one of the supporting blocks is provided with a layer of resilient material.

9. Sealing unit according to claim 1, wherein the endless conveying belts are comprised of a heat-resistant and preferably anti-stick material.

10. Sealing apparatus comprising a sealing unit according to claim 1.

11. Sealing apparatus according to claim 10, further comprising a gas supply unit for the supply of gas between two layers of film material to be connected, which gas supply unit comprises a gas outflow opening which, in film feed through direction, is located at least partly upstream of the facing conveying surface parts of the two endless conveying belts.

12. Sealing apparatus, preferably according to claim 10, comprising a guiding element, preferably an elongated guiding element, more preferably a substantially rod-shaped guiding element, extending substantially counter to the film feed-through direction, preferably at least partly upstream of the air or gas outflow opening.

13. Sealing apparatus according to claim 12, further comprising a knife, preferably wherein the knife is provided at the guiding element, more preferably upstream of the air or gas outflow opening.

14. Sealing apparatus according to claim 13, wherein the knife is positioned at a lateral side of the guiding element, preferably wherein said knife is substantially extending in a plane substantially parallel with film material being conveyed in use, more preferably wherein said knife is positioned off centre with respect to the guiding element, seen in the direction of the thickness of film material being conveyed in use, wherein said thickness direction extends substantially transverse to the feed-through direction and substantially transverse to the width of the film material being conveyed in use.

15. Method for manufacturing gas filled bags from preconfigured film material, wherein the gas filled bags are manufactured by means of a sealing unit according to claim 1.

16. Gas filled bag manufactured by the method of claim 15.
